(19) United States
(12) Patent Application Publication
(10) Pub. No.: US 2010/0073141 A1
(43) Pub. Date: Mar. 25, 2010

(54) IC TAG READING DEVICE

(75) Inventors: Nobukatsu Nishida, Otsu-shi (JP); Toshio Kudo, Amagasaki-shi (JP); Kazuyuki Kashihara, Amagasaki-shi (JP); Masahiro Fukui, Osaka-shi (JP); Katsunori Hosotani, Arida-shi (JP); Kiyoyuki Sasaki, Muko-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignees: Nobukatsu NISHIDA, Otsu-shi, Shiga (JP); MITSUBISHI CABLE INDUSTRIES, LTD., Tokyo (JP); SAGAWA PRINTING CO., LTD., Kyoto (JP)

(21) Appl. No.: 12/517,185

(22) PCT Filed: Dec. 3, 2007
(86) PCT No.: PCT/JP2007/073324

§ 371 Date: Jun. 1, 2009

(30) Foreign Application Priority Data
Dec. 4, 2006 (JP) 2006-326708
Dec. 4, 2006 (JP) 2006-326709
Mar. 23, 2007 (JP) 2007-076162

(51) Int. Cl. H04Q 5/22

(52) U.S. Cl. 340/10.3

(57) ABSTRACT

On one side of a passageway for an identification subject 10 with an IC tag 7 to pass, an antenna is provided for reading information stored in the IC tag 7, and a front wave-absorbing wall 2 and a rear wave-absorbing wall 3 are provided protruding from the vicinity of the front and rear edges of the antenna 8 toward the passageway 13 such that the walls narrow the half-power angle θ of the radio wave radiated from the antenna 8 over a horizontal plane. A wave-absorbing side wall 1 is also provided on the other side of the passageway 13. With such a structure, the propagation area of the radio wave can be controlled so that the reading area of the IC tag 7 can be limited, and the influence of the reflected wave is suppressed.

### TECHNICAL FIELD

The present invention is directed to an IC tag reading device.

### BACKGROUND ART

In recent years, a so-called RFID (Radio Frequency Identification) system, in which a tag with an embedded IC chip of about several centimeters (hereinafter, referred to as “IC tag”) stores information that can be read in a noncontact manner via an electromagnetic wave or field, is used as a next-generation identification technology that can replace barcodes. A device for reading information in such a system is known by the name of IC tag reading device or RFID reader (see Patent Documents 1 and 2). Applications of such a system to traceability management of products during distribution, stock management in a library, and various other fields are expected.

Patent Document 1: Japanese Laid-Open Patent Publication No. 2005-267077

Patent Document 2: Japanese Laid-Open Patent Publication No. 2006-20083

### DISCLOSURE OF INVENTION

### Problems to be Solved by the Invention

An IC tag reading device which employs a radio wave in, for example, UHF (Ultra-High Frequency) band (800 MHz to 960 MHz) is capable of covering a long communication distance, which is a major advantage of this device. However, on the other hand, the IC tag reading device of this type involves the following problems. The IC tag reading device may unintentionally read information of an IC tag existing in a place undesirable for reading due to its wide communication area. The IC tag reading device may fail to correctly read information of an IC tag due to interference by an adjacent system of the same type. A direct wave from an antenna and reflected waves by various surrounding structures synthesize with one another, and an IC tag makes no response especially at a point where the waves attenuate one another (Null point). In view of these problems, the key is to appropriately control the electromagnetic environment.

Thus, a principal objective of the present invention is to provide an IC tag reading device which is less affected by reflected waves and which reads IC tags within a limited area by controlling the area of radio wave propagation.

### Means for Solving the Problems

To achieve the above objective, an IC tag reading device of the present invention includes: an antenna provided on one side of a passageway for an identification subject with an IC tag to pass, the antenna being adapted to radiate a radio wave for reading information stored in the IC tag; front and rear wave-absorbing walls which are respectively provided on front and rear sides with respect to the antenna in a direction of passage of the identification subject in the passageway such that a half-power angle of the radio wave radiated from the antenna over a horizontal plane is narrowed; and a wave-absorbing side wall provided on the other side of the passageway.

In the above structure, two antenna units, each consisting of an antenna and front and rear wave-absorbing walls, may be provided on both sides of the passageway. In this case, wave-absorbing side walls are provided on the respective sides of the passageway opposite to the corresponding antennas.

From the above structure, any one of the set of front and rear wave-absorbing walls and the wave-absorbing side wall may be omitted so long as the indispensable conditions are met.

In the above structure, the front and rear wave-absorbing walls may be arranged such that the half-power angle of the radio wave radiated from the antenna is narrowed to 40° or smaller.

The wave-absorbing side wall may include a plurality of vertically-elongated rectangular plates which are foldably/spreadably connected together at vertical edges by connectors such that the whole wave-absorbing side wall is capable of being opened and closed between a folded state and a spread state. In this structure, the wave-absorbing side wall may have leak detection IC tags on vertical edges at both ends in the direction of passage of the identification subject in the passageway for confirming that a radio wave radiated from the antenna is equal to or smaller than a predetermined leak tolerance. In this case, the leak detection IC tags may be detachably fixed to the vertical edges of the wave-absorbing side wall. The wave-absorbing side wall may have a wheel on a lower edge.

### EFFECTS OF THE INVENTION

The present invention provides the following significant effects.

In an IC tag reading device of the present invention, a front wave-absorbing wall and a rear wave-absorbing wall are respectively provided on the front and rear sides with respect to an antenna that is provided on one side of a passageway, the front and rear wave-absorbing walls protruding from the vicinity of the front and rear edges of the antenna toward the passageway such that the walls narrow the half-power angle of the radio wave radiated from the antenna over a horizontal plane, while a wave-absorbing side wall is provided on the other side of the passageway. With such a simple structure, the propagation area of the radio wave radiated from the antenna can be controlled (zone-controlled) so that reading of tag information at an unintended location can be prevented. There is no probability that a Null point occurs due to synthesis with reflected wave in the readable area, so that failure in reading of tag information can be prevented. Also, interference by a radio wave radiated from another adjacent antenna can be prevented. Therefore, even in a RFID system with a large communication area, the present invention contributes to improvement in precision and certainty in management of articles subjected to identification (identification subjects).

### BRIEF DESCRIPTION OF DRAWINGS

FIG. 1 is a perspective view showing the whole structure of an IC tag reading device according to embodiment 1 of the present invention.

FIG. 2 is a plan view.

FIG. 3 is a front view showing an antenna.

FIG. 4 is a plan view for illustration.

FIG. 5 is a front view of a principal part.

FIG. 6 is a front view of a principal part of the first variation.

FIG. 7 is a front view of a principal part of the second variation.

FIG. 8 is a front view of a principal part of the third variation.

FIG. 9 is a front view of a principal part of the fourth variation.

FIG. 10 is a front view of a principal part of the fifth variation.

FIG. 11 is a front view of a principal part of the sixth variation.

FIG. 12 is a plan view for illustration, showing an electric field distribution in example 1.

FIG. 13 is a plan view for illustration, showing an electric field distribution in example 2.

FIG. 14 is a plan view for illustration, showing an electric field distribution in example 3.

FIG. 15 is a plan view for illustration, showing an electric field distribution in example 4.

FIG. 16 is a plan view for illustration, showing an electric field distribution in example 5.

FIG. 17 is a plan view for illustration, showing an electric field distribution in example 6.

FIG. 18 is a chart of characteristics, also showing the results of the measurement of the electric field strength in examples 1-3 and example 5.

FIG. 19 is a perspective view showing the whole structure of an IC tag reading device according to embodiment 2 of the present invention.

FIG. 20 is a perspective view showing the whole structure of an IC tag reading device according to embodiment 3 of the present invention.

FIG. 21 is a plan view.

FIG. 22 is a plan view showing a wave-absorbing side wall.

FIG. 23 is a perspective view of a principal part.

FIGS. 24(a) and 24(b) are cross-sectional views taken along line A-A of FIG. 23.

FIG. 25 is a perspective view of a principal part.

FIG. 26 is a plan view for illustration of a principal part.

FIG. 27 is a perspective view showing the whole structure of an IC tag reading device according to embodiment 4 of the present invention.

FIG. 28 is a plan view.

### DESCRIPTION OF REFERENCE SYMBOLS

1 wave-absorbing side wall
2 front wave-absorbing wall
3 rear wave-absorbing wall
7 IC tag
8 antenna
10 identification subject
13 passageway
17 front vertical edge
18 rear vertical edge
19 rectangular plate
24 lower edge
25 wheel
26 connector
27 leak detection IC tag
θ half-power angle
θc controlled half-power angle

### BEST MODE FOR CARRYING OUT THE INVENTION

Hereinafter, embodiments of the present invention are described with reference to the drawings.

### Embodiment 1

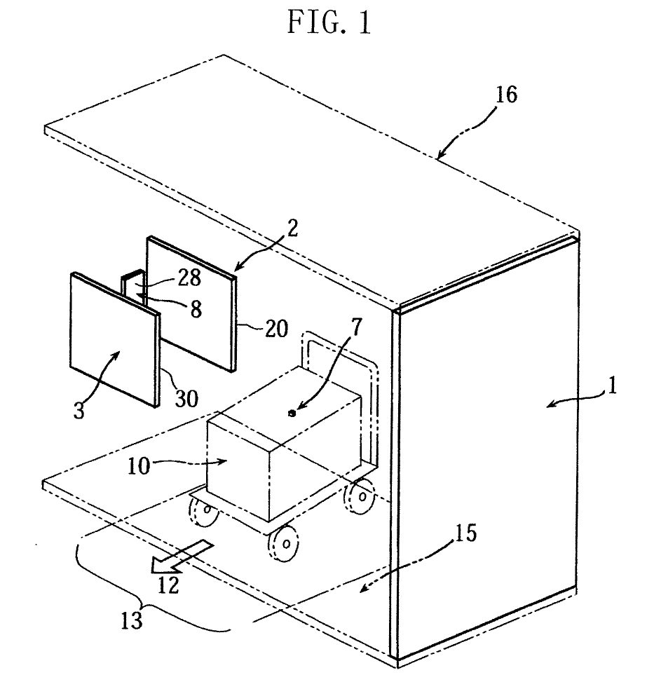

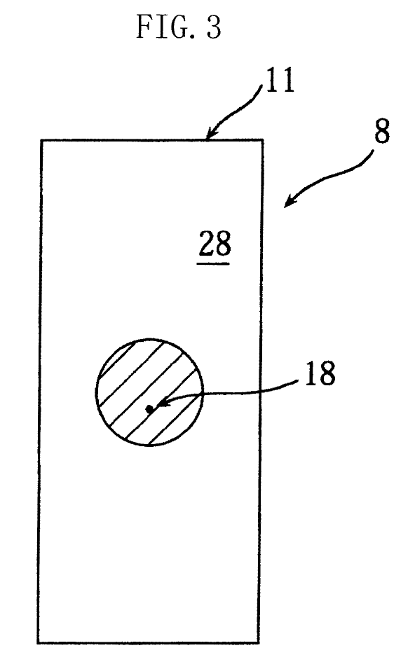

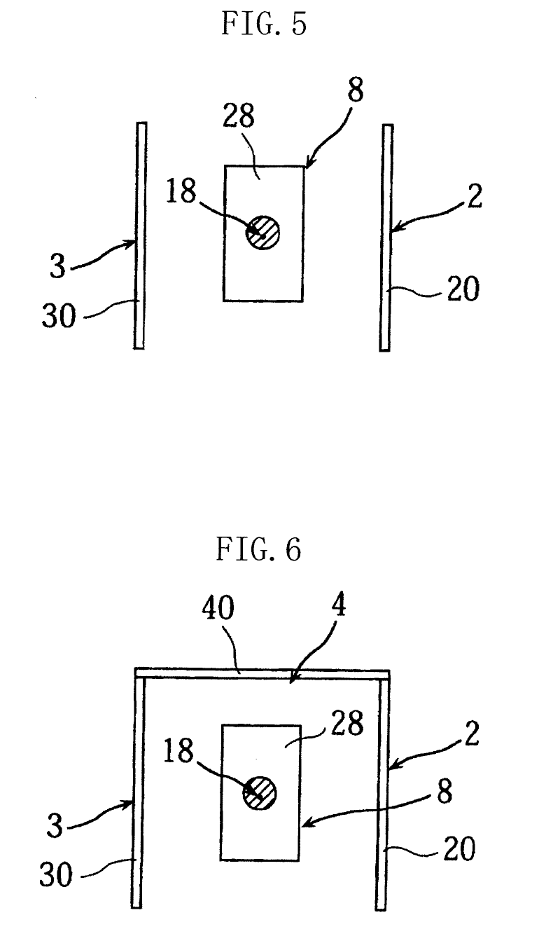

FIGS. 1 to 5 show the whole structure of an IC tag reading device according to embodiment 1 of the present invention. This IC tag reading device includes a transmission/reception antenna 8 on one side of a passageway 13 for an identification subject 10 with an IC tag 7 to pass. The antenna 8 radiates a radio wave in the UHF band (800 MHz to 960 MHz) for reading information stored in the IC tag 7. The antenna 8 is held by a holding member (not shown) such that a wave radiation surface 28 of the antenna 8 is parallel to the orientation of the passageway 13 (the passage direction 12 of the identification subject 10) when seen from the above and that a feeding point 18 at which the radio wave is radiated or received is at a predetermined height from the floor (e.g., 1,300 mm).

The case 11 of the antenna 8 has such a planar rectangular shape that the length of the long side is 700 mm to 730 mm, the length of the short side is 300 mm to 330 mm, and the thickness is 35 mm to 45 mm. The case 11 is composed of an aluminum case with a vinyl chloride cover. The hatched circular area around the feeding point 18 represents a radio wave radiation area. The feeding point 18 is at a position slightly lower than the center of the radio wave radiation area.

The floor (lower surface) of the passageway 13 may be provided with a wave-absorbing flooring member 15 which prevents reflection of the radio wave by the floor. The ceiling (upper surface) of the passageway 13 may be provided with a wave-absorbing ceiling member 16 which prevents leak of the radio wave.

Referring to FIGS. 1, 2, 4 and 5, the reading device of this embodiment includes a front wave-absorbing wall 2 and a rear wave-absorbing wall 3 which are vertically standing and extending from the vicinity of the front and rear edges of the antenna 8 toward the passageway 13. The front wave-absorbing wall 2 and the rear wave-absorbing wall 3 serve to narrow the half-power angle θ of a beam area 6 of a radio wave radiated from the antenna 8 over a horizontal plane.

Specifically, the front wave-absorbing wall 2 and the rear wave-absorbing wall 3 have a planar rectangular shape and are arranged such that the front wall 2 and the rear wall 3 sandwich the antenna 8 in the middle therebetween and are perpendicular to the antenna 8 (i.e., perpendicular to the passage direction 12). The front wall 2 and the rear wall 3 respectively have vertical edges 20 and 30 (on the passageway 13 side) which are at the same distance from the passageway 13.

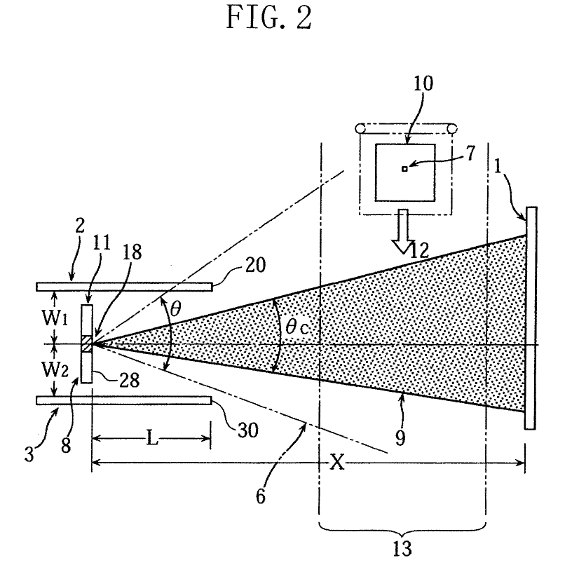

Note that, herein, the left-hand side of a person viewing the passageway 13 from the position of the antenna 8 (upper side of FIG. 2) is referred to as “front side”, and the right-hand side (lower side of FIG. 2) as “rear side”.

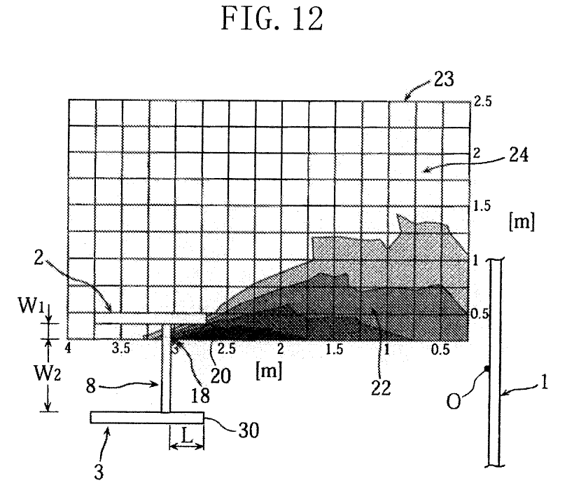

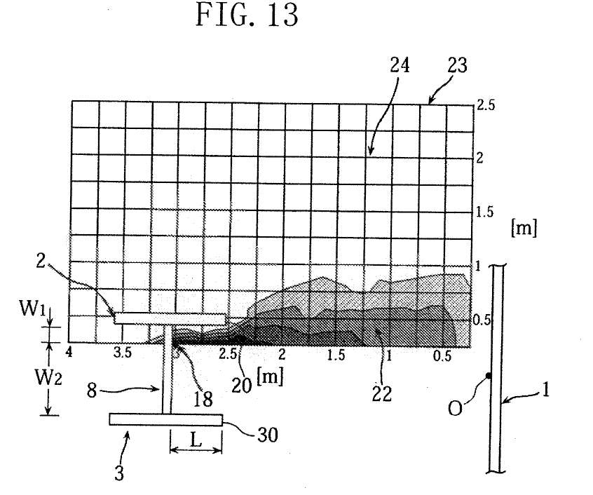

The antenna 8 can be placed in different positions. In one example, the feeding point 18 of the antenna 8 is in the middle between the front side and the rear side, i.e., the distance between the front wall 2 and the feeding point 18, W₁, is equal to the distance between the rear wall 3 and the feeding point 18, W₂ (see FIGS. 2 to 5). In other examples, the feeding point 18 of the antenna 8 is positioned such that W1<W2 holds (see FIG. 12 to 15) or W2<W1 holds. The antenna 8 of this embodiment performs transmission and reception of the radio wave at a single point, i.e., the feeding point 18, but an antenna having a transmission point and a reception point at different positions may alternatively be used. In this case, the transmission point is coincident with the feeding point 18 of this embodiment (although not shown).

Reference symbol θ represents the half-power angle of the radio wave radiated from the antenna 8 which would be achieved when the front wall 2 and the rear wall 3 are not provided. Reference symbol 6 denotes the beam area defined by the half-power angle θ. The beam area 6 slightly tends toward the front side relative to the normal to the wave radiation surface 28 of the antenna 8 due to the radiation characteristics of the antenna 8.

Reference symbol θc represents a controlled half-power angle which is achieved by narrowing (zone-controlling) the half-power angle θ of the radio wave radiated from the antenna 8 by the front wall 2 and the rear wall 3. The controlled half-power angle θc is set in the range of θc=20° to 40°. The zone-controlled area 9 is shaded with dots.

Should the controlled half-power angle θc exceed)40° (θc>40°), the radio wave would spread excessively wide, resulting in the probability of reading information of an IC tag outside the reading area.

Placing the lower limit on the controlled half-power angle θc secures a certain extent of the radio wave so that a long readable area (distance, passage duration) for IC tags passing through the gate can accordingly be secured. Thus, reading failure can more surely be prevented. From this point of view, the controlled half-power angle θc is more preferably 20° or greater)(θc≧20°).

The half-power angle is an angle formed by points at which the power of the radiated radio wave is half of that at the strongest point (the value of the maximum power minus 3 dB) and represents the sharpness of the beam.

Extrusion dimension L of the front wall 2 and the rear wall 3 is set to an electrical length of 0.5×λ to 3×λ (λ represents the wavelength of the radio wave) under the conditions that the controlled half-power angle θc is within the aforementioned range. At the same time, the dimensions of the spaces between the front wall 2 and rear wall 3 and the front edge and rear edge of the antenna 8 are set to 0.5×λ or smaller (0 (zero) means that they are in contact) under the same conditions. The front edge of the antenna 8 and the front wall 2, and the rear edge of the antenna 8 and the rear wall 3, may be positioned with a space therebetween (see FIGS. 1 to 5) or may be positioned without a space so as to be in contact (see FIGS. 12 to 14). For example, in the case of 953 MHz and L=150 mm, the dimension of the space is represented by about 0.48×λ.

The front wave-absorbing wall 2 and the rear wave-absorbing wall 3 have a multilayered structure including, for example, polycarbonate, an adhesive material, an Ag film, PET (polyethylene terephthalate), a vacant space (a member having a vacant space), PET, an indium tin oxide (ITO) film, an adhesive material, and polycarbonate, which are formed in this order.

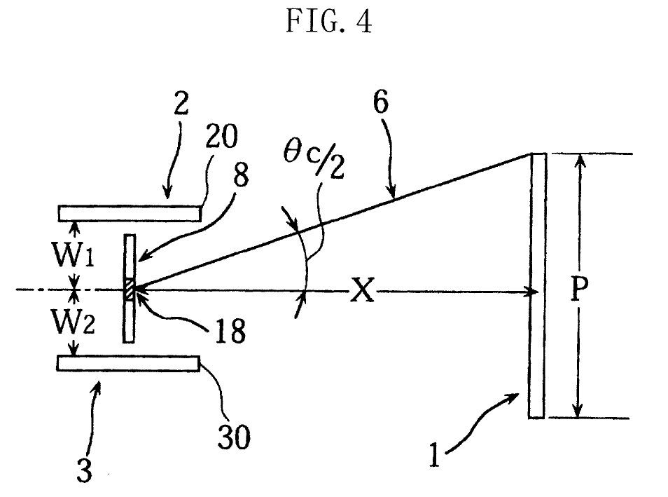

Referring to FIG. 1, FIG. 2 and FIG. 4, the reading device of this embodiment includes a planar wave-absorbing side wall 1 on the other side of the passageway 13 opposite to the antenna 8. The wave-absorbing side wall 1 stands parallel to the wave radiation surface 28 of the antenna 8. When the reading device includes the wave-absorbing ceiling member 16 and flooring member 15, the upper and lower edges of the wave-absorbing side wall 1 and the edges of the wave-absorbing ceiling member 16 and flooring member 15 are connected without a space therebetween so that leak of the radio wave is further prevented.

Lengthwise dimension P of the wave-absorbing side wall 1 between the front side and the rear side corresponds to the beam area 6 of the controlled half-power angle θc in the presence of the front wall 2 and the rear wall 3. Specifically, the lengthwise dimension P satisfies the formula of P≧2Xtan(θc/2) where X represents the distance between the antenna 8 and the side wall 1. The side wall 1 is installed so as to receive the whole radio wave of the beam area 6 without leak.

FIGS. 6 to 8 show three variations, variations 1 to 3, which are different from the reading device shown in FIG. 1 to FIG. 5 in that a wave-absorbing top wall 4 and bottom wall 5 are provided for narrowing the upper and lower parts of the beam area 6 radiated from the antenna 8.

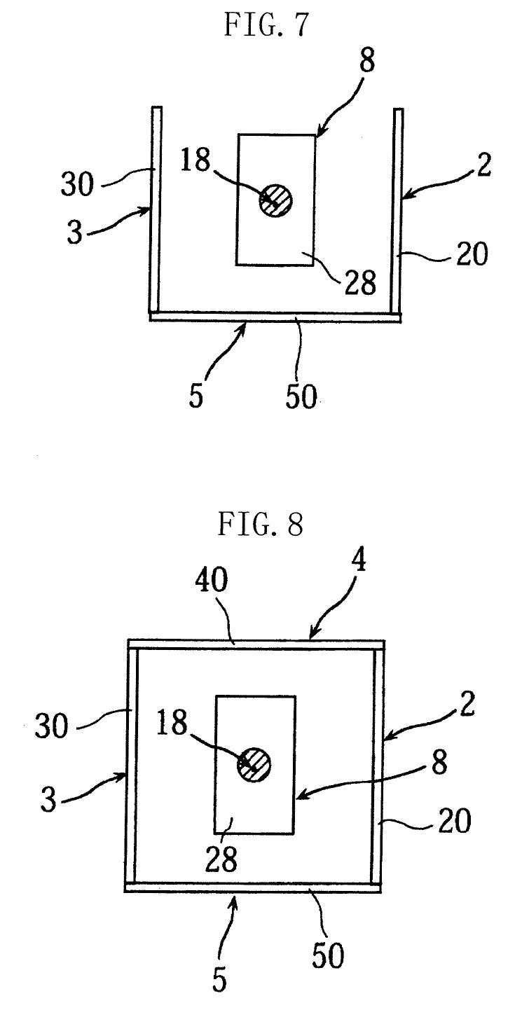

Variation 1 (FIG. 6) includes the horizontal wave-absorbing top wall 4 above the antenna 8, extending in the direction from the antenna 8 to the passageway 13. The top wall 4 extends toward the passageway 13 such that a transverse edge 40 of the top wall 4 (on the passageway 13 side) is coincident with the positions of the vertical edges 20 and 30 of the front wall 2 and rear wall 3. Variation 2 (FIG. 7) includes the horizontal wave-absorbing bottom wall 5 below the antenna 8, extending in the direction from the antenna 8 to the passageway 13. The bottom wall 5 extends toward the passageway 13 such that a transverse edge 50 of the bottom wall 5 (on the passageway 13 side) is coincident with the positions of the vertical edges 20 and 30 of the front wall 2 and rear wall 3. Variation 3 (FIG. 8) includes both the wave-absorbing top wall 4 and the wave-absorbing bottom wall 5 which are provided in the same way as illustrated in FIG. 6 and FIG. 7.

With the top wall 4 and the bottom wall 5, the angles of upward and downward spread of the vertical component of the radio wave can be controlled, so that reading of unintended IC tags and interference by an adjacent system of the same type can be further prevented.

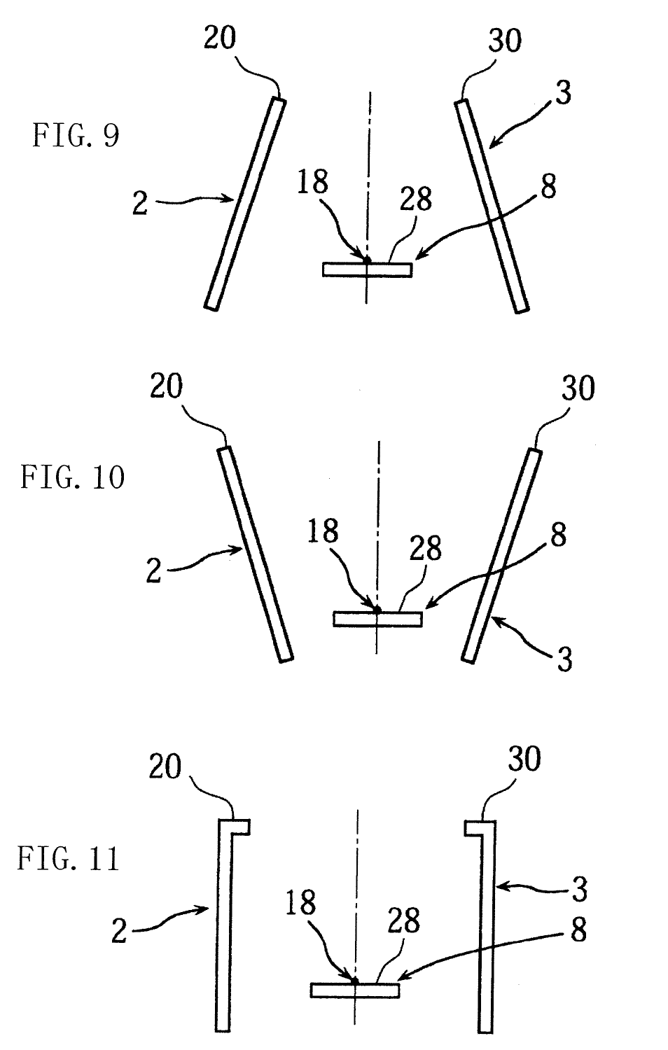

FIG. 9 to FIG. 11 show three other variations of the front wall 2 and the rear wall 3 (variations 4 to 6). In variation 4 (FIG. 9), the front wall 2 and the rear wall 3 are in an open-vertex ̂ arrangement when seen from the top such that the space between the front wall 2 and the rear wall 3 is narrower at a position closer to the passageway 13. In the reading device of variation 5 (FIG. 10), the front wall 2 and the rear wall 3 are in an open-vertex V arrangement when seen from the top such that the space between the front wall 2 and the rear wall 3 is wider at a position closer to the passageway 13. In the reading device of variation 6 (FIG. 11), the front wall 2 and rear wall 3 extending in parallel are bent inward at the vertical edges 20 and 30 so as to foam small flanges respectively extending toward the rear and front sides. The variations 4 to 6 may also be combined with the top wall 4 and/or the bottom wall 5 described in variations 1-3.

—Experiments—

The following is our analysis of the results of actual measurements of the radio wave of the antenna 8.

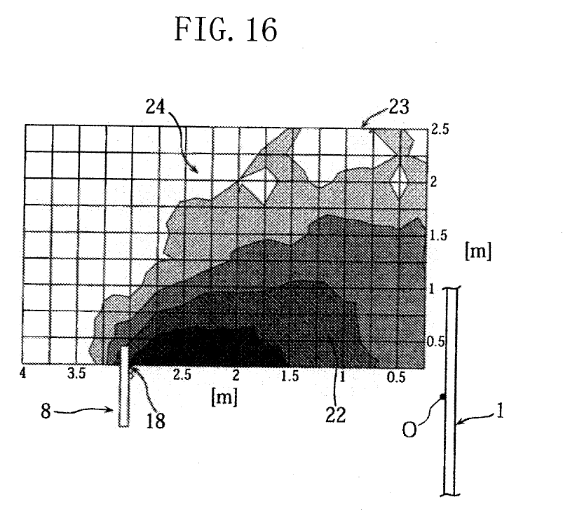

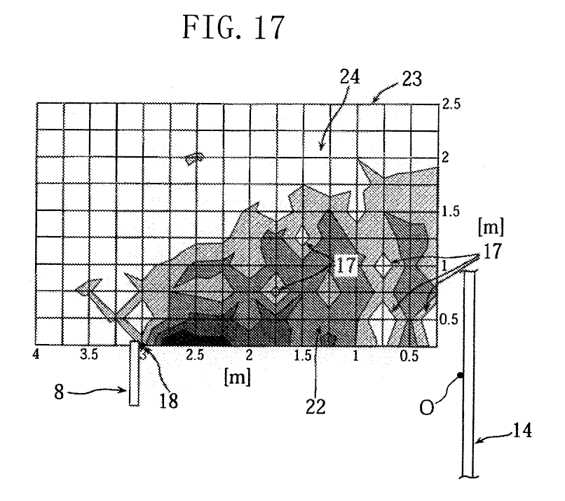

With the reading device shown in FIG. 1 and FIG. 2, four experiments (experiments 1-4) were conducted to examine the radio wave environment (measurement of electric field distribution) around the antenna 8 under varying conditions, such as installment location. The results of experiments 1-4 are shown in FIG. 12 to FIG. 15. The result of experiment 5 in which the measurement was conducted in the absence of the front wall 2 and the rear wall 3 is shown in FIG. 16. The measurement result of experiment 6 is shown in FIG. 17. Inside the frame 23 is the area of measurement around the antenna 8 in a horizontal plane by a reception antenna (not shown) that will be described later. Numerals attached around the measurement area 23 denote the positions (coordinates) marked in a direction from reference point O at the longitudinal center of the side wall 1 toward the antenna 8 and in a direction from reference point O toward the front side. The measurement was conducted at a number of positions with the location of the reception antenna varying within the measurement area 23.

The front wave-absorbing wall 2 and the rear wave-absorbing wall 3 had the same dimensions: the height was 2,000 mm, the width was 1,000 mm, and the thickness was 80 mm including the dimension of the vacancy of 73 mm (note that FIG. 1 only shows part of the front wall 2 and the rear wall 3). The distance between the antenna 8 and the wave-absorbing side wall 1, distance X, was X=3,000 mm. The feeding point 18 of the antenna 8 was at the height of 1,300 mm above the floor surface. The feeding point 18 was closer to the front side than the longitudinal center of the side wall 1 is.

The frequency of the radio wave of the measured electric field distribution for the antenna 8 was 953 MHz. The reception antenna installed in the measurement area 23 for measurement was a vertical polarization dipole antenna. The measurement was conducted at the height of 1,300 mm.

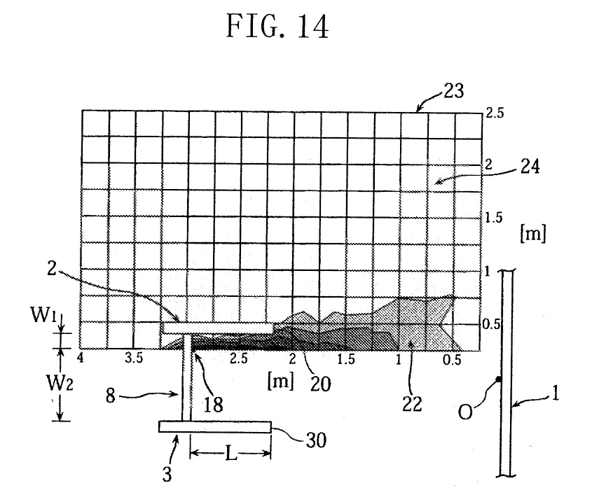

FIG. 12 (experiment 1), FIG. 13 (experiment 2) and FIG. 14 (experiment 3) show the electric field distributions achieved when the extrusion dimension L of the reading device was L=300 mm, L=500 mm and L=750 mm, respectively. FIG. 16 (experiment 5) shows the electric field distribution achieved when the measurement was conducted in the absence of the front wall 2 and the rear wall 3. Unshaded area indicated by numeral 24 represents an unreadable area in which the electric field strength is lower than a certain value so that information of the IC tag 7 cannot be successfully read out. Shaded area indicated by numeral 22 represents a readable area in which the electric field strength is equal to or higher than the certain value so that information of the IC tag 7 can be successfully read out. In an area with denser shading, information can be read stronger.

In experiments 1-3, the detected readable area 22 was narrow because of zone control by the front wall 2 and the rear wall 3 whereas the readable area 22 was wide in experiment 5. As seen from the charts, the readable area 22 was narrower as the extrusion dimension L became larger. Note that the measurement was not conducted in the area outside the measurement area 23 on the rear side, but naturally, the readable area is also zone-controlled in this unmeasured area.

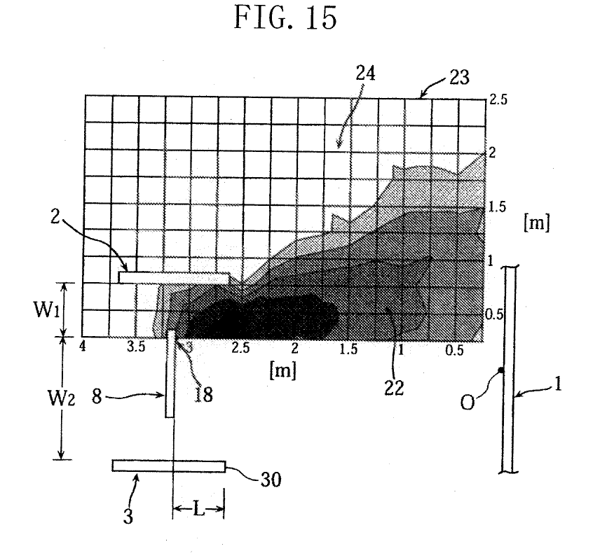

FIG. 15 (experiment 4) shows the electric field distribution achieved when L=500 mm and the dimension of the space between the front wall 2 and the rear wall 3 was about twice that of experiments 1-3. In experiment 4, the readable area 22 was excessively wide so that tag information was read from an unintended location. This is an example of inappropriate zone control.

FIG. 17 (experiment 6) shows the electric field distribution achieved when the reading device of experiment 1 included none of the front wall 2 and the rear wall 3 and used a wave-reflecting side wall 14 in place of the wave-absorbing side wall 1. In experiment 6, the direct wave from the antenna 8 and the reflected wave from the wave-reflecting side wall 14 synthesize with each other so that the readable area 22 includes a plurality of Null points where the waves attenuate each other. At the Null points, an IC tag makes no response.

Although not shown, a conventional solution to this disadvantage is covering the antenna with a wave shield. In this case, it is difficult to estimate the route of a wave reflected by the wave shield.

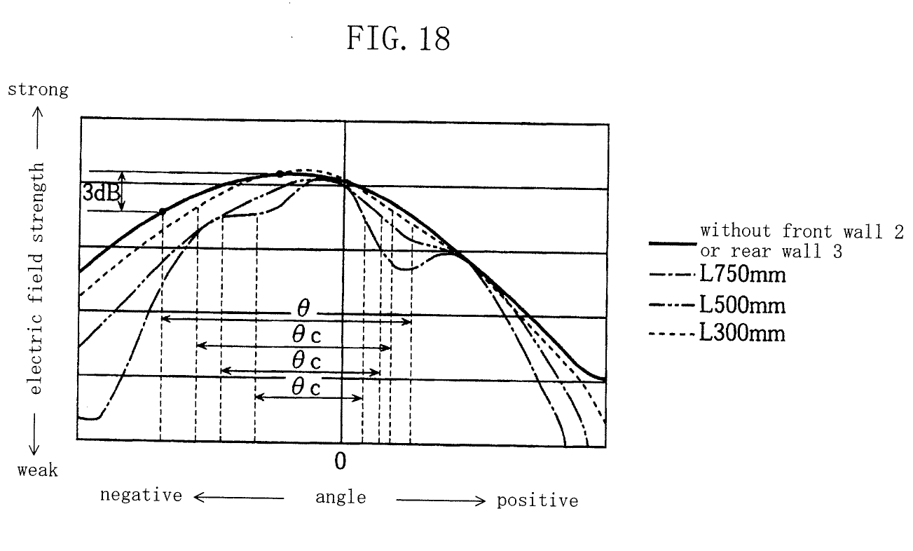

FIG. 18 shows the variation of the electric field strength measured in positions at a certain distance from the antenna 8 (feeding point 18) in the measurements of experiments 1-3 and experiment 5. The horizontal axis represents the angle from a normal to the antenna 8 which passes through the feeding point 18 in the area between the front and rear sides where positive angle values are on the rear side and negative angle values on the front side. The vertical axis represents the electric field strength. As seen from the graph of FIG. 18, the half-power angle of the radio wave at which the electric field strength is smaller than the strongest point by 3 dB was greatest in the example without the front wall 2 and the rear wall 3 (FIG. 16), angle θ. The controlled half-power angle θc decreased as the extrusion dimension L increased (in the order of experiment 1, experiment 2 and experiment 3).

The RFID wave in the UHF band which is used in this embodiment has such a characteristic that the wave propagates up to a distant position, but the wave radiated by the antenna 8 can be effectively zone-controlled as seen from the above measurement results, so that there is no probability of reading information from an IC tag residing at an unintended location. Also, interference by a wave from another antenna is prevented, so that information of IC tags can be correctly read out. There is no probability that a Null point occurs, so that reading failure can be prevented.

In the conventional example with a wave reflector, the antenna used is a highly directional antenna, such as parabolic antenna and horn antenna, which increases the antenna gain. In this embodiment, the antenna gain is not affected, so that the zone control can be carried out without changing the value of EIRP (effective isotropically radiated power: product of antenna gain and transmission power) which is defined as the strength of the radio wave in the UHF band.

As described above, the IC tag reading device of embodiment 1 includes the antenna 8 on one side of the passageway 13 for an identification subject 10 with an IC tag 7 to pass. The antenna 8 reads information stored in the IC tag 7. The antenna 8 is sandwiched by the front wave-absorbing wall 2 and the rear wave-absorbing wall 3 which are vertically standing and protruding from the vicinity of the front and rear edges of the antenna 8 toward the passageway 13 such that the walls 2 and 3 narrow the half-power angle θ of the radio wave radiated from the antenna 8 over a horizontal plane. The IC tag reading device further includes the wave-absorbing side wall 1 on the other side of the passageway 13. With such a simple structure, the radiated wave can be controlled (zone-controlled) so that reading of tag information from an unintended location can be prevented. Also, interference by a radio wave radiated from another adjacent antenna can be prevented. There is no probability that a Null point occurs in the radiation area, so that failure in reading of tag information can be prevented. Therefore, in distribution of products using a RFID system with a large communication area, only products subjected to identification (identification subjects 10) can more surely be identified and managed. The antenna 8 has improved radiation pattern characteristics without being accompanied by increase of the antenna gain, which is technically rational.

The controlled half-power angle θc, achieved by narrowing the half-power angle θ of the radio wave radiated from the antenna 8 by using a pair of wave-absorbing walls, the front wall 2 and the rear wall 3, is 40° or smaller (preferably, 20° or greater). Therefore, reading of information from an IC tag outside the reading area can be prevented. The area in which the radio wave can reach is not excessively narrowed so that failure in reading of information from a tag passing through the gate (passageway 13) can more surely be prevented. Thus, management of the identification subjects 10 in distribution can more surely be conducted. Further, the passage-wise dimension of the wave-absorbing side wall 1 between the front side and the rear side can be reduced. Therefore, the space for installation is accordingly reduced and the material cost can be minimized.

### Embodiment 2

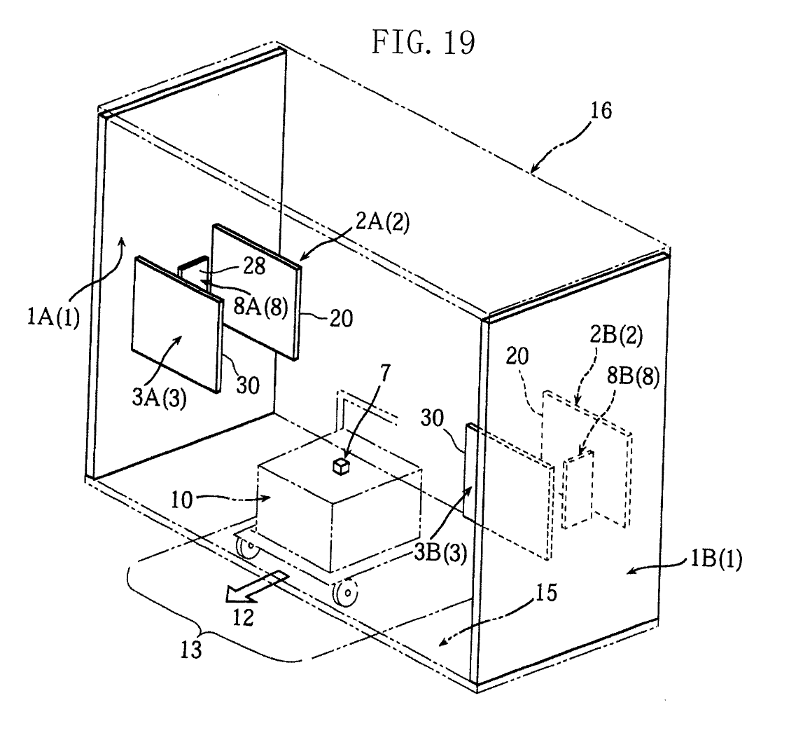

FIG. 19 shows the whole structure of an IC tag reading device according to embodiment 2 of the present invention. Embodiment 2 is different from embodiment 1 in that the IC tag reading device includes antennas 8 on both sides of the passageway 13 and wave-absorbing side walls 1 on the respective sides of the passageway 13 opposite to the corresponding antennas 8. The antennas 8A and 8B are at the same height such that their wave radiation surfaces 28 are in parallel and face each other. Each of the side walls 1 is standing at the back of the antenna 8 (a side of the antenna 8 opposite to the passageway 13), and the wave-absorbing side wall 1A on one side and the wave-absorbing side wall 1B on the other side have the same dimensions as the side wall 1 illustrated in FIG. 1 to FIG. 4 and are parallel to each other. On each side, the positional relationship of the antenna 8 and the front wall 2 and rear wall 3 is same as the structure illustrated in FIG. 1 to FIG. 5. Preferably, an additional antenna may be provided below or on the lower surface of the ceiling member 16 of FIG. 19, although not shown.

The antenna 8A on the one side and the antenna 8B on the other side alternately performs transmission and reception with shifted timings. Specifically, when one of the antenna 8A and the antenna 8B performs transmission/reception (ON), the other antenna is OFF. In this way, these antennas are alternately turned ON and OFF. A radio wave radiated from each of the antennas 8 is zone-controlled in the same manner as described for experiments 1-3 of embodiment 1. Therefore, even if a large identification subject 10 carries an IC tag 7 in a decentered position in the lateral direction, any one of the antennas 8 can read information from the tag 7. Also, even if a large number of identification subjects 10 with IC tags 7 are carried by a dolly, information can more surely be read from each one of the IC tags 7 without failure by any one of the antennas 8.

As described above, the IC tag reading device of embodiment 2 includes the antennas 8 on both sides of the passageway 13 for an identification subject 10 with an IC tag 7 to pass. The antennas 8 read information stored in the IC tag 7. Each of the antennas 8 is sandwiched by the front wave-absorbing wall 2 and the rear wave-absorbing wall 3 which are vertically standing and protruding from the vicinity of the front and rear edges of the antenna 8 toward the passageway 13 such that the walls 2 and 3 narrow the half-power angle θ of the radio wave radiated from the antenna 8 over a horizontal plane. The IC tag reading device further includes the wave-absorbing side walls 1 on the respective sides of the passageway 13 opposite to the respective antennas 8. With such a structure, the same effects as those of embodiment 1 can be achieved. The antenna 8A on the one side and the antenna 8B on the other side alternately perform transmission and reception with shifted timings. Therefore, even if a large identification subject 10 carries an IC tag 7 in a decentered position in the lateral direction, any one of the antennas 8 can read information from the tag 7. Also, even if a large number of identification subjects 10 with IC tags 7 are carried by a dolly, information can more surely be read from each one of the IC tags 7 without failure by any one of the antennas 8. The antenna 8 has improved radiation pattern characteristics without being accompanied by increase of the antenna gain, which is technically rational.

### Embodiment 3

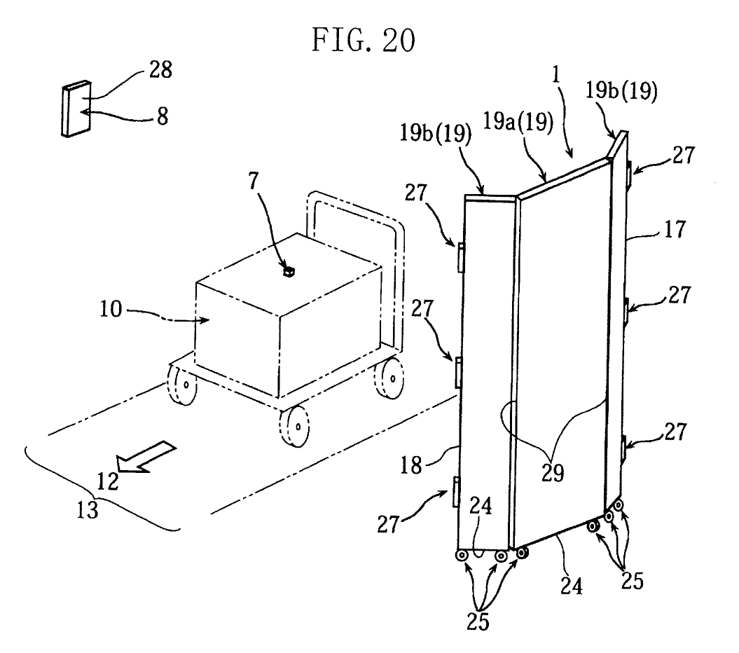

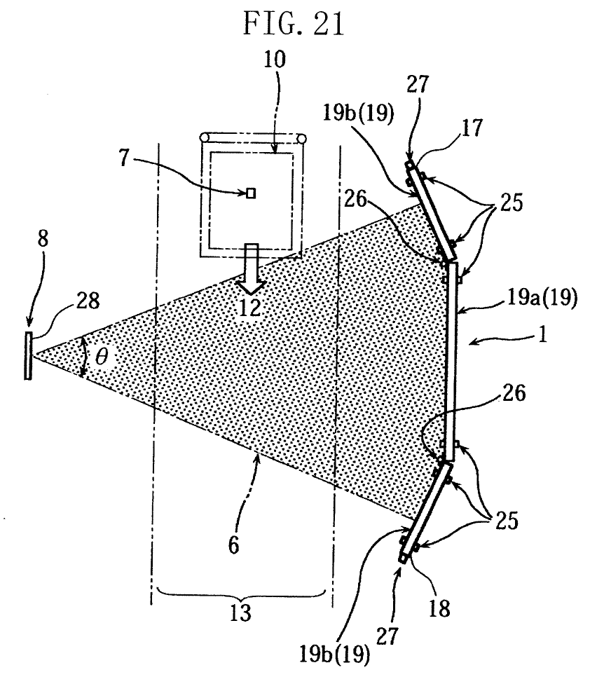

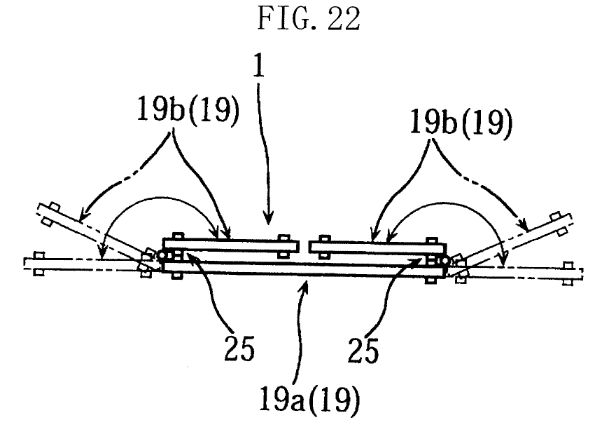

FIGS. 20 and 21 show the whole structure of an IC tag reading device according to embodiment 3 of the present invention. This IC tag reading device includes an antenna 8 on one side of a passageway 13 for an identification subject 10 with an IC tag 7 to pass. The antenna 8 radiates and receives a radio wave in the UHF band (800 MHz to 960 MHz) for reading information stored in the IC tag 7. The antenna 8 is held by a holding member (not shown) at a predetermined height from the floor (e.g., 1,300 mm) such that a wave radiation surface 28 of the antenna 8 is parallel to the orientation of the passageway 13 (the passage direction 12 of the identification subject 10) when seen from the above.

An example of the antenna 8 has a planar rectangular case where the length of the long side is 700 mm to 730 mm, the length of the short side is 300 mm to 330 mm, and the thickness is 35 mm to 45 mm. The case is composed of an aluminum case and a vinyl chloride cover. The feeding point is at a position slightly lower than the center of a circular radio wave radiation area.

The IC tag reading device of this embodiment includes a wave-absorbing side wall 1 on the other side of the passageway 13 opposite to the antenna 8. The wave-absorbing side wall 1 is composed of a plurality of vertically-elongated rectangular plates 19 which are foldably/spreadably connected together by connectors 26 at vertical edges such that the whole wave-absorbing side wall is capable of being opened and closed between a folded state and a spread state. In the example described herein, the wave-absorbing side wall 1 includes three rectangular plates 19, including a rectangular plate 19a at the center and foldable rectangular plates 19b foldably/spreadably connected at the front and rear vertical edges 29 of the center rectangular plate 19a by connectors 26, such as hinges. The rectangular plates 19 each have wheels 25 on the lower edge 24. The wave-absorbing side wall 1 is placed vertically standing on the floor such that the face of the center rectangular plate 19a is parallel to the wave radiation surface 28 of the antenna 8. Each rectangular plate 19 has a multilayered structure including, for example, polycarbonate, an adhesive material, an Ag film, PET, a vacant space (a member having a vacant space), PET, an ITO film, an adhesive material, and polycarbonate, which are formed in this order. Note that, in this embodiment, the entrance side at which the identification subject 10 enters in the passage direction indicated by the arrow 12 is referred to as the front side.

In the wave-absorbing side wall 1, the width dimension of the center rectangular plate 19a is twice that of the foldable rectangular plate 19b or more so that the both rectangular plates 19b can be compactly folded over the center rectangular plate 19a (see FIG. 22). Due to the wheels 25, the foldable rectangular plates 19b can be smoothly folded over and spread from the center rectangular plate 19a, and also, the side wall 1 as a whole can be smoothly transferred.

Note that θ represents the radiation angle of a beam 6 in a horizontal plane. The beam 6 is part of the radio wave radiated from the antenna 8 by which information of an IC tag can be read. For example, the radiation angle θ is set so as to be the half-power angle. The half-power angle refers to an angle formed by points at which the power of the radiated radio wave is half of that at the strongest point (the value of the maximum power minus 3 dB) and represents the sharpness of the beam.

The beam area 6 shown in FIG. 21 has equal spread angles toward the front side and the rear side from the wave radiation surface 28 of the antenna 8 but may slightly tend toward the front or rear side relative to the normal to the wave radiation surface 28 due to the radiation characteristics of the antenna.

Referring to FIG. 20 to FIG. 24(a), the wave-absorbing side wall 1 is provided with leak detection IC tags 27 at the front vertical edge 17 and the rear vertical edge 18 for confirming that the radio wave radiated from the antenna 8 is equal to or smaller than a predetermined leak tolerance value. The leak detection IC tags 27 each have an elongated rectangular shape and are detachably fixed to the front vertical edge 17 of the front foldable rectangular plate 19b and to the rear vertical edge 18 of the rear foldable rectangular plate 19b. Specifically, 21 denotes a tag holder in the form of a bag where the IC tag 27 can be put into and taken out of as necessary. The tag holder 21 has a hook-and-loop fastener 22 formed in the external surface, while the front vertical edge 17 of the front foldable rectangular plate 19b and the rear vertical edge 18 of the rear foldable rectangular plate 19b have hook-and-loop fasteners 20. With these fasteners, the tag holders 21 are detachably fixed to the rectangular plates 19b.

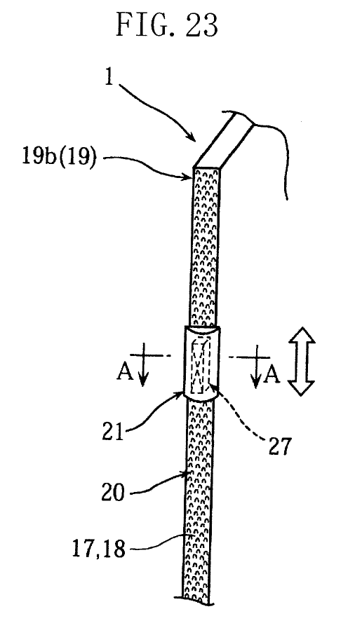

The tag holders 21 carrying the IC tags 27 therein are fixed to the front vertical edge 17 and the rear vertical edge 18 of the rectangular plates 19b. Since the tag holders 21 are detachable, the vertical positions of the IC tags 27 can be freely changed according to the installation height of the antenna 8 and the characteristics of the radiated radio wave, such as magnitude and radiation angle (see FIG. 23).

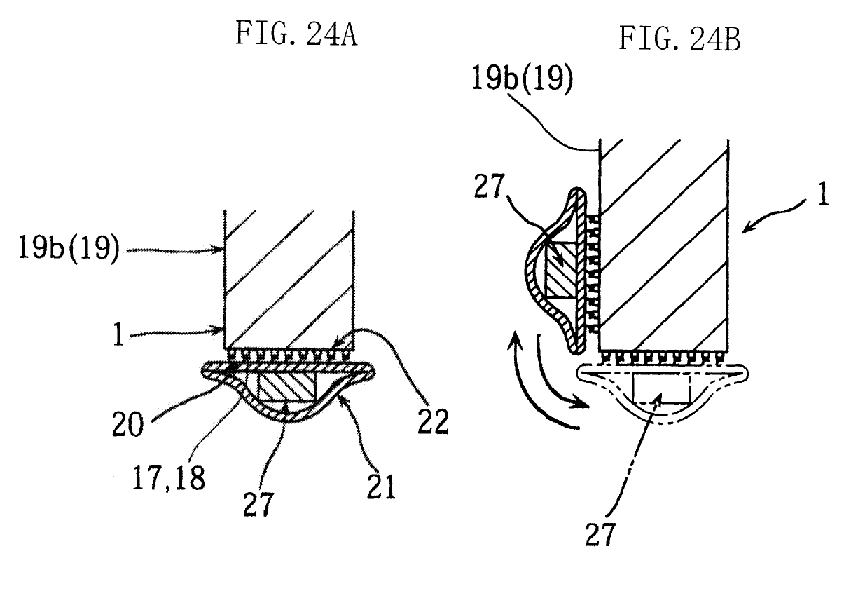

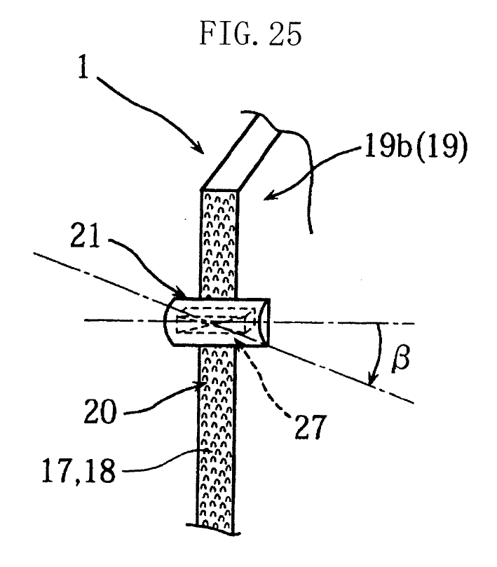

The posture of the IC tag 27 can be set to a vertical orientation (FIG. 23) or a horizontal orientation (FIG. 25) in accordance with the polarization plane of the radio wave radiated from the antenna 8. The front vertical edge 17 and the rear vertical edge 18 of the rectangular plates 19b are each provided with one or more IC tags 27. As illustrated in FIG. 24(b) by solid lines and phantom lines, the position of fixture of the IC tag 27 may be changed from the front vertical edge 17 or rear vertical edge 18 to another surface near the vertical edge, and vice versa. As illustrated in FIG. 25, the IC tag 27 may be fixed in a diagonal orientation with desired angle β (angle β is variable).

Note that the tag holders 21 may be omitted, while the IC tags 27 themselves may have hook-and-loop fasteners 22 by which the IC tags 27 are directly fixed to the wave-absorbing side wall 1 in a detachable fashion. The hook-and-loop fasteners 20 and 22 may be replaced by a double-stick tape for fixing the IC tags 27 to the wave-absorbing side wall 1.

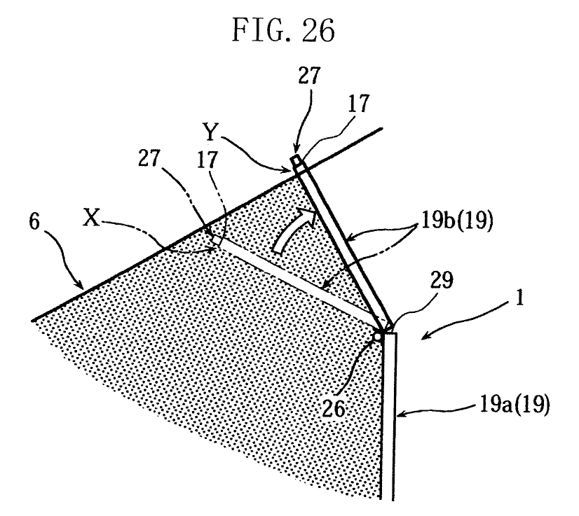

FIG. 26 is a plan view of a principal part which illustrates the relationship between the wave-absorbing side wall 1 and the beam area 6. When the front foldable rectangular plate 19b is in position X, the front vertical edge 17 and the leak detection IC tag 27 are in the beam area 6, so that the radio wave leaks to the opposite side of the wave-absorbing side wall 1 (opposite to the passageway 13 and hence the antenna 8). In this case, the antenna 8 reads information of the IC tag 27 to confirm leak of the radio wave (the radio wave passing by the wave-absorbing side wall 1).

When leak of the radio wave is thus confirmed, the foldable rectangular plate 19b is further spread from position X so that the front vertical edge 17 and the IC tag 27 are out of the extent of the beam area 6 (position Y), and the radio wave does not leak to pass by the wave-absorbing side wall 1. In other words, the rectangular plate 19b is spread to a position where the radio wave fails to read the information of the IC tag 27. The same applies to the rear rectangular plate 19b of the wave-absorbing side wall 1, although not shown.

The procedure of setting the IC tag reading device having the above structure is now described. In transportation to a place of installation, the wave-absorbing side wall 1 is in a folded state where two foldable rectangular plates 19b are compactly folded over the center rectangular plate 19a (as illustrated by solid lines in FIG. 22) so that the wave-absorbing side wall 1 can be smoothly transported. After arriving at the place of installation, the wave-absorbing side wall 1 is installed such that the face of the antenna 8 and the center rectangular plate 19a of the wave-absorbing side wall 1 are in parallel to each other with the passageway 13 interposed therebetween. Then, as described above, the foldable rectangular plates 19b are spread to a predetermined angle such that the radiated radio wave does not leak to pass by the wave-absorbing side wall 1. After the angle adjustment of the foldable rectangular plates 19b, the wave-absorbing side wall 1 is fixed by fixing means (not shown) so as not to be unintentionally moved, whereby the setting is complete.

As described above, the IC tag reading device of this embodiment includes the antenna 8 on one side of the passageway 13 for an identification subject 10 with an IC tag 7 to pass. The antenna 8 radiates a radio wave for reading information stored in the IC tag 7. The IC tag reading device also includes the wave-absorbing side wall 1 on the other side of the passageway 13. The wave-absorbing side wall 1 is composed of a plurality of vertically-elongated rectangular plates 19 which are foldably/spreadably connected together by connectors 26 at vertical edges such that the whole wave-absorbing side wall is capable of being opened and closed between a folded state and a spread state. The wave-absorbing side wall 1 is provided with leak detection IC tags 27 at the front vertical edge 17 and the rear vertical edge 18 for confirming that the radio wave radiated from the antenna 8 in a horizontal plane is equal to or smaller than a predetermined leak tolerance value. With this feature, it can be confirmed whether or not the radio wave radiated from the antenna 8 leaks to the opposite side of the wave-absorbing side wall 1 (opposite to the passageway 13 and hence the antenna 8). Therefore, reading of tag information from an unintended location can more surely be prevented. Since the whole wave-absorbing side wall 1 is capable of being opened and closed between a folded state and a spread state, the spread state of the side wall 1 is modified when leak of the radio wave is detected by the IC tags 27 in order to eliminate the leak of the radio wave.

Since the leak detection IC tags 27 are detachably fixed to the vertical edges 17 and 18 of the wave-absorbing side wall 1, the vertical positions of the IC tags 27 can be freely changed according to, for example, the installation height of the antenna 8 and the radiation angle θ of the radiated radio wave. Therefore, it can more surely be confirmed whether or not leak of the radio wave is present (whether or not the radio wave is equal to or smaller than a predetermined leak tolerance value). When the IC tag 27 has an elongated shape, the posture of the IC tag 27 can be set variously, such as a horizontal orientation or a vertical orientation, in accordance with the polarization plane of the radiated radio wave. Therefore, it can more surely be confirmed whether or not leak of the radio wave is present.

Since the wave-absorbing side wall 1 has wheels 25 on the lower edge 24, the side wall 1 can be smoothly swung between a folded state and a spread state. Therefore, the work efficiency improves in wall adjustment by opening and closing the side wall 1 such that the radio wave does not leak to pass by the side wall 1, or in transportation or installation of the side wall 1.

### Embodiment 4

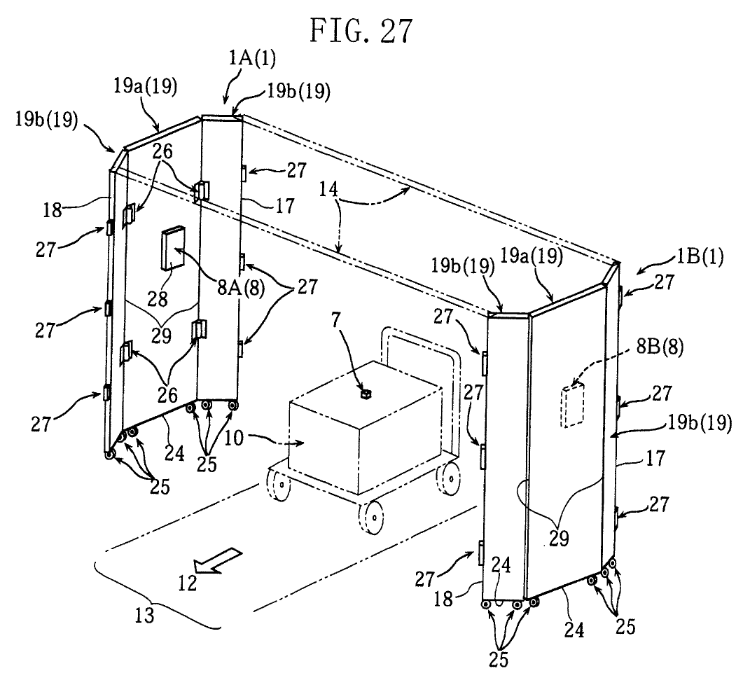

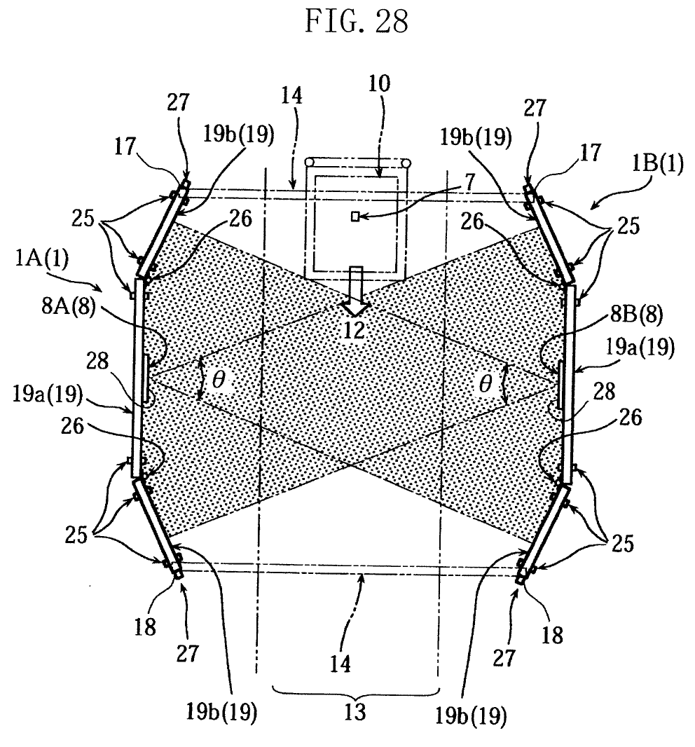

FIG. 27 and FIG. 28 show the whole structure of an IC tag reading device according to embodiment 4 of the present invention. Embodiment 4 is different from embodiment 3 in that the IC tag reading device includes antennas 8 on both sides of the passageway 13 and wave-absorbing side walls 1 on the respective sides of the passageway 13 opposite to the corresponding antennas 8. The antennas 8A and 8B on the both sides are fixed to the front surfaces of the center rectangular plates 19a of the side walls 1 (facing the passageway 13) at the same height or at different heights such that their wave radiation surfaces 28 are in parallel and face each other. The wave-absorbing side wall 1A and the wave-absorbing side wall 1B on the both sides are placed standing such that their center rectangular plates 19a are parallel to each other and face each other. The locations of the respective wave-absorbing side walls 1 and the antennas 8 facing thereon, the installation height of the antennas 8, and leak detection IC tags 27 provided on the respective side walls 1 are the same as those described in embodiment 3.

The pair of wave-absorbing side walls 1A and 1B may be detachably connected together by connecting rods 14 at upper parts of the front edges 17 and upper parts of the rear edges 18. Note that these connecting rods 14 may be omitted.

The procedure of setting this IC tag reading device includes installing, at the place of installation, the pair of antennas 8A and 8B and the pair of wave-absorbing side walls 1A and 1B so as to face each other over the passageway 13, and subsequently, the reading device is set in the same way as the procedure of embodiment 3, whereby the setting is complete. Thereafter, the pair of wave-absorbing side walls 1A and 1B are preferably connected together by the connecting rods 14 so that the walls are stably installed. Specifically, change in position of the pair of side walls 1A and 1B and abrupt swinging of the foldable rectangular plates 19b can be prevented by the connecting rods 14.

The antenna 8A on one side and the antenna 8B on the other side alternately perform transmission and reception with shifted timings. Therefore, even if a large identification subject 10 carries an IC tag 7 in a decentered position in the lateral direction, the tag information can be more surely read out as compared with an one-antenna reading device. Also, even if a large number of identification subjects 10 with IC tags 7 are carried by a dolly, information can more surely be read from each one of the IC tags 7 as compared with an one-antenna reading device.

As described above, the IC tag reading device of embodiment 4 includes the antennas 8 on both sides of the passageway 13 for an identification subject 10 with an IC tag 7 to pass. The antennas 8 read information stored in the IC tag 7. The IC tag reading device also includes the wave-absorbing side walls 1 on the respective sides of the passageway 13 opposite to the respective antennas 8. The wave-absorbing side walls 1 are each composed of a plurality of vertically-elongated rectangular plates 19 which are foldably/spreadably connected together by connectors 26 at vertical edges such that the whole wave-absorbing side wall is capable of being opened and closed between a folded state and a spread state. Each of the wave-absorbing side walls 1 is provided with leak detection IC tags 27 at the front vertical edge 17 and the rear vertical edge 18 for confirming that the radio wave radiated from the antenna 8 in a horizontal plane is equal to or smaller than a predetermined leak tolerance value. With such a structure, the same effects as those of embodiment 3 can be achieved. The antenna 8A on the one side and the antenna 8B on the other side alternately perform transmission and reception with shifted timings. Therefore, for example, even if a large identification subject 10 carries an IC tag 7 in a decentered position in the lateral direction, information can be read more surely. Also, even if a large number of identification subjects 10 with IC tags 7 are carried by a dolly, information can more surely be read from each one of the IC tags 7. The antenna 8 has improved radiation pattern characteristics without being accompanied by increase of the antenna gain, which is technically rational.

In embodiment 3 and embodiment 4, the wave-absorbing side wall 1 is composed of three rectangular plates 19 which are foldably/spreadably connected together but is not limited to this example. The design of the wave-absorbing side wall 1 may be modified as necessary. The wave-absorbing side wall 1 may be composed of two rectangular plates 19 which are foldably/spreadably connected together, or may alternatively be composed of four or more rectangular plates 19 which are foldably/spreadably connected together (not shown). In the case where the wave-absorbing side wall 1 may be composed of four or more rectangular plates 19, the IC tags 27 are also detachably fixed to the front vertical edge 17 of the frontmost rectangular plate 19 and the rear vertical edge 18 of the rearmost rectangular plate 19. Note that, in an example where the maximum spread angle of the wave-absorbing side wall 1 is 180° so that the wave-absorbing side wall 1 can be spread to form a planar wall, any upright-supporting member (not shown) is necessary for preventing the wall 1 from falling over. In another example where the fully-spread state is achieved with the angle shown in FIG. 21 and FIG. 28, the wave-absorbing side wall 1 is capable of standing on the floor by itself so that the upright-supporting member can be omitted.

The antenna 8 may be installed above or under the passageway 13, although not shown. In the gate structure as described in embodiment 4 where a pair of side walls 1 are connected together by connecting rods 14, each connecting rod 14 may be provided with a leak detection IC tag 27 for detecting leak of the radio wave radiated from the antenna 8.

The wave-absorbing side wall 1 of embodiment 3 or embodiment 4 may be replaced by the wave-absorbing side wall 1 of embodiment 1 or embodiment 2. The antenna 8 of embodiment 3 or embodiment 4 may be provided with the front wave-absorbing wall 2 and the rear wave-absorbing wall 3 of embodiment 1.

1. An IC tag reading device, comprising:
an antenna provided on one side of a passageway for an identification subject with an IC tag to pass, the antenna being adapted to radiate a radio wave for reading information stored in the IC tag;
front and rear wave-absorbing walls which are respectively provided on front and rear sides with respect to the antenna in a direction of passage of the identification subject in the passageway such that a half-power angle of the radio wave radiated from the antenna over a horizontal plane is narrowed; and
a wave-absorbing side wall provided on the other side of the passageway.

2. An IC tag reading device, comprising:
antennas provided on both sides of a passageway for an identification subject with an IC tag to pass, the antennas being adapted to radiate a radio wave for reading information stored in the IC tag;
front and rear wave-absorbing walls which are respectively provided on front and rear sides with respect to the corresponding antennas in a direction of passage of the identification subject in the passageway such that a half-power angle of the radio wave radiated from the corresponding antenna over a horizontal plane is narrowed; and
wave-absorbing side walls provided on the respective sides of the passageway opposite to the corresponding antennas.

3. An IC tag reading device, comprising:
an antenna provided on one side of a passageway for an identification subject with an IC tag to pass, the antenna being adapted to radiate a radio wave for reading information stored in the IC tag; and
front and rear wave-absorbing walls which are respectively provided on front and rear sides with respect to the antenna in a direction of passage of the identification subject in the passageway such that a half-power angle of the radio wave radiated from the antenna over a horizontal plane is narrowed.

4. An IC tag reading device, comprising:
antennas provided on both sides of a passageway for an identification subject with an IC tag to pass, the antennas being adapted to radiate a radio wave for reading information stored in the IC tag; and
front and rear wave-absorbing walls which are respectively provided on front and rear sides with respect to the corresponding antennas in a direction of passage of the identification subject in the passageway such that a half-power angle of the radio wave radiated from the corresponding antenna over a horizontal plane is narrowed.

5. The IC tag reading device of claim 1, wherein the front and rear wave-absorbing walls are arranged such that the half-power angle of the radio wave radiated from the antenna is narrowed to 40° or smaller.

6. An IC tag reading device, comprising:
an antenna provided on one side of a passageway for an identification subject with an IC tag to pass, the antenna being adapted to radiate a radio wave for reading information stored in the IC tag; and
a wave-absorbing side wall provided on the other side of the passageway.

7. An IC tag reading device, comprising:
antennas provided on both sides of a passageway for an identification subject with an IC tag to pass, the antennas being adapted to radiate a radio wave for reading information stored in the IC tag; and
wave-absorbing side walls provided on the respective sides of the passageway opposite to the corresponding antennas.

8. The IC tag reading device of claim 1, wherein
the wave-absorbing side wall includes a plurality of vertically-elongated rectangular plates which are foldably/spreadably connected together at vertical edges by connectors such that the whole wave-absorbing side wall is capable of being opened and closed between a folded state and a spread state, and
the wave-absorbing side wall has leak detection IC tags on vertical edges at both ends in the direction of passage of the identification subject in the passageway for confirming that a radio wave radiated from the antenna is equal to or smaller than a predetermined leak tolerance.

9. The IC tag reading device of claim 8, wherein the leak detection IC tags are detachably fixed to the vertical edges of the wave-absorbing side wall.

10. The IC tag reading device of claim 8, wherein the wave-absorbing side wall has a wheel on a lower edge.

11. The IC tag reading device of claim 2, wherein the front and rear wave-absorbing walls are arranged such that the half-power angle of the radio wave radiated from the antenna is narrowed to 40° or smaller.

12. The IC tag reading device of claim 3, wherein the front and rear wave-absorbing walls are arranged such that the half-power angle of the radio wave radiated from the antenna is narrowed to 40° or smaller.

13. The IC tag reading device of claim 4, wherein the front and rear wave-absorbing walls are arranged such that the half-power angle of the radio wave radiated from the antenna is narrowed to 40° or smaller.

14. The IC tag reading device of claim 2, wherein
the wave-absorbing side wall includes a plurality of vertically-elongated rectangular plates which are foldably/spreadably connected together at vertical edges by connectors such that the whole wave-absorbing side wall is capable of being opened and closed between a folded state and a spread state, and
the wave-absorbing side wall has leak detection IC tags on vertical edges at both ends in the direction of passage of the identification subject in the passageway for confirming that a radio wave radiated from the antenna is equal to or smaller than a predetermined leak tolerance.

15. The IC tag reading device of claim 6, wherein
the wave-absorbing side wall includes a plurality of vertically-elongated rectangular plates which are foldably/spreadably connected together at vertical edges by connectors such that the whole wave-absorbing side wall is capable of being opened and closed between a folded state and a spread state, and
the wave-absorbing side wall has leak detection IC tags on vertical edges at both ends in the direction of passage of the identification subject in the passageway for confirming that a radio wave radiated from the antenna is equal to or smaller than a predetermined leak tolerance.

16. The IC tag reading device of claim 7, wherein
the wave-absorbing side wall includes a plurality of vertically-elongated rectangular plates which are foldably/spreadably connected together at vertical edges by connectors such that the whole wave-absorbing side wall is capable of being opened and closed between a folded state and a spread state, and
the wave-absorbing side wall has leak detection IC tags on vertical edges at both ends in the direction of passage of the identification subject in the passageway for confirming that a radio wave radiated from the antenna is equal to or smaller than a predetermined leak tolerance.
